(19) United States
(12) Patent Application Publication
(10) Pub. No.: US 2011/0050002 A1
(43) Pub. Date: Mar. 3, 2011

(54) ENERGY SUPPLY SYSTEM WITH A PROTECTED SOLAR MODULE

(75) Inventor: Riccardo De Luca, Wabern (CH)

(73) Assignee: ESMOLO LTD., Bern (CH)

(21) Appl. No.: 12/920,509

(22) PCT Filed: Dec. 10, 2008
(86) PCT No.: PCT/EP08/67263

§ 371 Date: Oct. 15, 2010

(30) Foreign Application Priority Data
Mar. 26, 2008 (EP) 08153341.6

(51) Int. Cl. H02N 6/00

(52) U.S. Cl. 307/149

(57) ABSTRACT

The energy supply system comprises at least one protected solar module with at least one photovoltaic cell and a local control unit connected to a switching module, which is controllable in such a way that the transfer of electrical energy from the photovoltaic cell via first and second wires of a power line to a load is interruptable in the event that a verification procedure that can be performed by the local control unit has provided a negative result. According to the present invention a chip-card with an electronic module is provided for each or for a plurality of solar modules comprising a first access code that corresponds to a second access code stored in a memory unit, and that a card-reader is provided.

The invention relates to an energy supply system with a protected solar module, particularly to an energy supply system for preventing unauthorized use of a protected solar module, to a solar module and to a method for operating said energy supply system.

### BACKGROUND OF THE INVENTION

Solar modules serve for receiving and converting solar energy into electrical energy that can be provided to a local or public power grid. An energy supply system for collecting solar energy and providing electrical energy may comprise only one or a plurality of solar modules.

Such solar modules comprise photovoltaic cells; magic slivers of silicon that convert the solar energy falling on them directly into electricity. Large scale applications of photovoltaic cells for power generation, either on the rooftops of houses or in large fields connected to the utility grid are promising as well to provide clean, safe and strategically sound alternatives to current methods of electricity generation.

Many factors, such as increasing environmental pollution and rising costs of fossil fuels, have contributed to the fact that solar energy is rapidly gaining in significance. Particularly the development of more powerful and more efficient solar modules, which are equipped with photovoltaic cells, is making the use of regenerative solar energy possible in a broad scale of applications.

However, while the advantages of such energy supply systems are convincing, it is important to note that the implementation of these energy supply systems, particularly large scale energy supply systems that comprise numerous solar modules, require considerable investments.

As described in [1], U.S. Pat. No. 6,650,031 B1, it often occurs that the solar modules are stolen or made use of by unauthorized third parties. Known means for preventing unauthorized use or theft of the solar modules consist, as a rule, of a solid housing in conjunction with a strong lock. These protection means have the disadvantage, however, of being easily broken open by force and, in addition need to be configured heavy and solid for efficient protection. Still further, solar modules may be stolen at their manufacturer's premises or when being delivered to the consumers.

Hence, in [1] a further solution is described that provides protection against unauthorized use or theft of a solar module which reliably prevents unauthorized use. In an energy supply system operating according to that solution, the power output is interrupted, when a solar module-sited disabling device fails to receive a second signal via the power line within a first predefined time after having sent a first signal to the consumer-sited enabling device via the power line. Thus, if an unauthorized user having tapped into or stolen the solar module connects a consumer to the solar module, the solar module-sited disabling device sends the first signal and disables power output when it fails to receive the second signal within the first predefined time. Hence, the solar module can only be used in the place where it was installed and where the second signal can be provided by the system and is worthless if installed in places where the second signal is not provided by the consumer-sited enabling device. As described further, the solar module-sited disabling device and the consumer-sited enabling device comprise a switching device for short-circuiting the wires of the power line to disable power transfer or to generate the aforementioned signals respectively.

Hence, with the solution provided in [1], it is assured that an energy supply system comprising a stolen solar module does not operate at all, due to the short circuited power line wires that also serve for exchanging messages between the solar module-sited disabling device and the consumer-sited enabling device.

Therefore, with the measures described in [1], stolen solar modules are worthless if installed in a location where a second specific signal is not provided. However, these measures also lead to undesirable results in various instances.

If, for example, solar modules have erroneously been exchanged within the manufacturer's premises, in the process of distribution or installation, then the installer is confronted with an energy supply system that does not operate and that does not provide any information about the cause of the shut-down of the energy supply system. In the event that a multifunction occurs in one of the panels with the result that the disabling device activates the crossbar switch, then the energy supply system is shut down by the described security measures, although there is no security problem. Still further, matching of the messages or codes that are exchanged between the solar module-sited disabling device and the consumer-sited enabling device may fail due to incorrect handling or assignment of codes.

As a consequence, several situations may arise, which are not security related and in which the personnel in charge of installation or maintenance is confronted with a blocked and non-responsive system. In order to resolve the problem the personnel in charge of installation or maintenance has practically only one option, namely to remove the solar panels, one by one, from the power line, until the short-circuit disappears. However this procedure involves considerable time and efforts.

Further, an important disadvantage of the solution described in [1] is the insecure handling of the codes. Codes must be entered into the consumer-sited enabling device and thus be made available to the service personnel with the risk that information will be made accessible to third parties. Further, handling and entering codes is cumbersome and may lead to errors. Further, in the event that the solar modules are transferred, the codes must be made available again. In this event it must be taken care that the retrieved codes correctly correspond to the solar modules, which most likely will create difficulties.

Further important is that the solution described in [1] requires a consumer-sited enabling device and is therefore not applicable in configurations, in which a central control unit is unavailable. For example in remote areas, in which solar modules are used to provide energy to remote telecommunications systems, measurement systems or illumination systems, the requirement of a central control unit may not be desirable.

In addition, in view of the information exchanged between the solar module-sited portion and the consumer-sited portion of this system, the risk results that this information could be detected and used by a third party to activate and unlawfully reuse a stolen solar module. The consumer-sited enabling device disclosed in [1] may comprise a chip card reader including a corresponding control processor, a numerical input keypad for enabling a metered power output, a wireless detector to detect the enable code by remote control or similar control systems. Since by means of the first and second signals a plurality of information signals can be exchanged between the solar module-sited portion and the consumer-sited portion it is thus possible to meter e.g. the power transmitted.

Further, it is possible, e.g. by means of the aforementioned chip card, to instantly implement debiting the chip card of the user corresponding to the metered power consumed. Hence, the chip card is dedicated to debiting purposes.

The present invention is therefore based on the object of providing an improved energy supply system with a protected solar module, as well as an improved method for operating said energy supply system and an improved protected solar module.

### SUMMARY OF THE INVENTION

The above and other objects of the present invention are achieved by an energy supply system, a protected solar module and a method for operating said energy supply system according to claim 1, claim 7, and claim 11 respectively.

The energy supply system comprises at least one protected solar module with at least one photovoltaic cell and with a local control unit connected to a switching module, which is controllable in such a way that the transfer of electrical energy from the photovoltaic cell via first and second wires of a power line to a load is interruptable in the event that a verification procedure that can be performed by the local control unit has provided a negative result.

According to the present invention a chip-card with an electronic module, i.e. a “chip”, is provided for each or for a plurality of solar modules comprising a first access code that corresponds to a second access code stored in a first location of a memory unit, and that a card-reader is provided, with which the first access code is transferable from the electronic module to a second location of the memory unit contained in the local control unit, which further comprises a program module that allows performing the verification procedure that involves comparing the first access code, which has been transferred to the memory unit, and the preset second access code, singularly or repeatedly. Preferably the first access code is read from the chip card and stored in a non-volatile memory of the local control unit, so that the transfer and verification procedures need only be executed once.

Hence the inventive solar modules can only be operated, if the chip-card is available for the initialisation of the system, i.e. for verification purposes. However, since the chip-card is held by the owner of the solar modules, only the holder of the chip-card can activate the solar modules. The access code is stored within the chip-card so that third parties, service personnel or even the owner of the solar modules do not have access to this code. Hence, it is not possible that the access code is openly transferred and may accidentally be disclosed to people that may have dishonest intentions. Moreover, the chip card can not be cloned unless using a special hardware. Unauthorised removal of a solar module is therefore not of benefit, if the related access code, which is stored in the chip-card, is not available. Hence, separately storing the chip-cards also protects the solar modules, on which a warning may be marked, such as “NOTE: INOPERABLE WITHOUT CHIP-CARD”.

The inventive solution can advantageously be applied in systems that comprise a central control unit equipped with a chip-card reader. In these embodiments the central control unit retrieves the first access code from the chip-card and transfers it to the solar module.

Further, in a preferred embodiment, a mobile card reader is provided that allows transferring the access code wirelessly to the solar modules by means of radio signals or optical signals. Hence, the electronic circuit of the solar modules may be encapsulated within transparent glass, plastic or special glue, which protects the circuitry against mechanical impacts or water. Further, the electronic circuit is preferably installed in such a way, that it can not be accessed for example under a glass layer of the solar module, unless destroying the solar module.

However, the chip-card allows protection of a solar module, even in the event that no central unit is present. In this case a card-reader is connectable to or integrated in the solar module. The card-reader may for example be realised with a combination of a receiver for the chip card that is connected to the local control unit, which comprises software for a card-reader. This embodiment is particularly advantageous for stand alone installations, in which a solar module is installed at a remote place.

In a further preferred embodiment a motion sensor, e.g. an acceleration sensor, is connected to the local control unit, which is designed to deactivate the functionality of the solar module preferably by erasing the first access code, which is stored in the memory unit of the local control unit, preferably a non-volatile memory, whenever a movement of the solar module is signalled by the motion sensor. Hence, in the event that the solar module is moved, before or after installation, the solar module will be deactivated, preferably by automatically erasing the first access code in the memory unit of the local control unit. The solar module is therefore not only protected against unauthorised removal up to the point, when is installed at the customer's premises but also afterwards. In the event that the solar module, which has been installed and properly been identified, is removed thereafter for any purpose, the motion sensor will deliver a signal that will exceed a preset threshold. Upon detection of this motion signal the local control unit will automatically deactivate the solar module, e.g. by erasing the memory content in the local control unit that has been retrieved from the chip-card. In order to detect the change of the memory content the verification process is repeatedly, e.g. periodically, performed by the local control unit and not only during the initial installation procedure, when the first access code is read from the chip-card. Hence, a solar module that has been deactivated must be initialised again by means of the related chip-card. In order to avoid erroneous erasures of the access code a threshold is provided which must be exceeded by the output signals of the motion sensors. Output signals of the motion sensors, which are caused by an impact of rain or hail, will not cause the deactivation.

Storing the first access code in non-volatile memory yields the advantage that activation procedures are performed only once during installation. Hence, during later operation, the first access code will never be transferred to the solar module and can therefore not be detected by third parties, who then could remove, reinstall and activate the solar modules at another place.

In a preferred embodiment the local control unit is designed to deactivate the solar module, preferably by erasing the first access code only, when a signal of the motion sensor and/or a change of impedance has been detected, which indicates the electrical disconnection of the solar module from the system. This change of impedance can be detected in several ways. In the event that the load is disconnected from the solar module, then the output voltage of the solar module may exceed a given threshold, which causes an output signal of a logic circuitry to be set. Hence a strong mechanical impact, which may be caused by an earthquake, will not lead to the deactivation of the solar module. However, instead of impedance measurement, the local control unit may also sense a control signal that is transmitted by the central control unit. In the event that the control signal is not detected within a certain time period the solar module will be deactivated.

A further important aspect of the invention is that the correspondence of chip-cards to related solar modules can easily be established. Hence, the inventive solution significantly facilitates the logistics of the solar modules. The manufacturer can deliver the solar modules together with the related chip-cards. However the chip-cards can also be delivered on a separate channel. For identification purposes the corresponding solar modules and chip-cards are provided with identical marks or identical serial numbers.

In another embodiment of the invention, in which the local control unit of the at least one solar module is connected, either via the power line or via a dedicated control line, to a central control unit, the first connection wire of the photovoltaic cell is connected to the first power line wire, the second connection wire of the photovoltaic cell is connected via the switching module to the second power line wire. Hence, by controlling the switching module the photovoltaic cell can be connected to and disconnected from the power line, if the local control unit did not successfully verify the adherence of the solar module to the energy supply system. With these measures, short-circuits on the power line wires are avoided, so that it is always possible to establish communication channels over the power line between the central control unit and the local control units of the installed solar modules. Hence, although the transfer of electrical energy from the installed solar modules may be disabled, the communication between the central control unit and the local control units can still be maintained. In the event of a failure of the inventive energy supply system, particularly during installation procedures, maintenance personnel can still access the installed solar modules and retrieve all related data out of the local control units. It may then be discovered that one or more solar modules do not belong to the installed energy supply system or that a malfunction occurred, although all installed solar modules correctly relate to the energy supply system. Hence, maintenance personnel can take the appropriate steps to correct the failure. However, if desired, the transfer of electrical energy can also be inhibited by short circuiting the output lines of the solar module.

In order to maintain the required communication the local control units and the central control unit preferably communicate over the power line. However, it is also possible that a communication channel is established over a dedicated communication line.

Further, by avoiding a short-circuit on the power line and by avoiding a short-circuit between the connection wires of the solar cells it is still possible to make advantageous use of the electrical energy generated by the solar cells in the event that one module does not work properly. On the one hand the local control unit, which is, possibly via power line wires, connected to the connection wires of the solar cell, may further be provided with electrical energy and thus can perform its functions, even after the verification procedures have failed. Still further, in the event that the verification procedures have failed, the electrical energy provided by the solar cells may be provided to a signalling module, which indicates the status of the solar module. For example, the signalling module may generate optical and/or acoustical signals. Based on these signals, maintenance personnel can easily locate a defective solar module or a solar module that does not belong to the installed energy supply system.

Preferably, the electrical energy provided by the solar cells is stored in an energy storage unit, which is providing energy to the local control unit at times, when the solar cells are unable to deliver energy.

In a preferred embodiment the central control unit and the local control units comprise communication units, which are designed to convert binary data into modulated signals and vice versa. Instead of interrupting the power transfer, as described in [1], modulated signals are exchanged between the control units. By these measures interruptions of the power transfer and related energy losses are avoided. Further, these measures allow the use of a plurality of solar modules with little communication efforts, e.g. by using networking protocols. Preferably, each solar module comprises a serial number, which serves for individually addressing the solar module. With these measures, for all installed solar modules status messages can advantageously be collected during verification or after all verification procedures have been completed. These measures may also be of benefit for later maintenance work, when the status and condition of the solar modules are of interest.

To further facilitate maintenance work, the location of the individual solar modules, e.g. the related position on the roof or on a wall, is stored in the central control unit. Hence, in the event of a failure the related solar module can easily be localised and replaced.

### BRIEF DESCRIPTION OF THE DRAWINGS

Some of the objects and advantages of the present invention have been stated, others will appear when the following description is considered together with the accompanying drawings, in which:

FIG. 1 shows an inventive energy supply system with a protected solar module 1;

FIG. 2 shows the solar module 1 of FIG. 1 in a preferred embodiment; and

FIG. 3 shows a further preferred embodiment of a solar module 1.

### DETAILED DESCRIPTION OF THE PREFERRED EMBODIMENTS

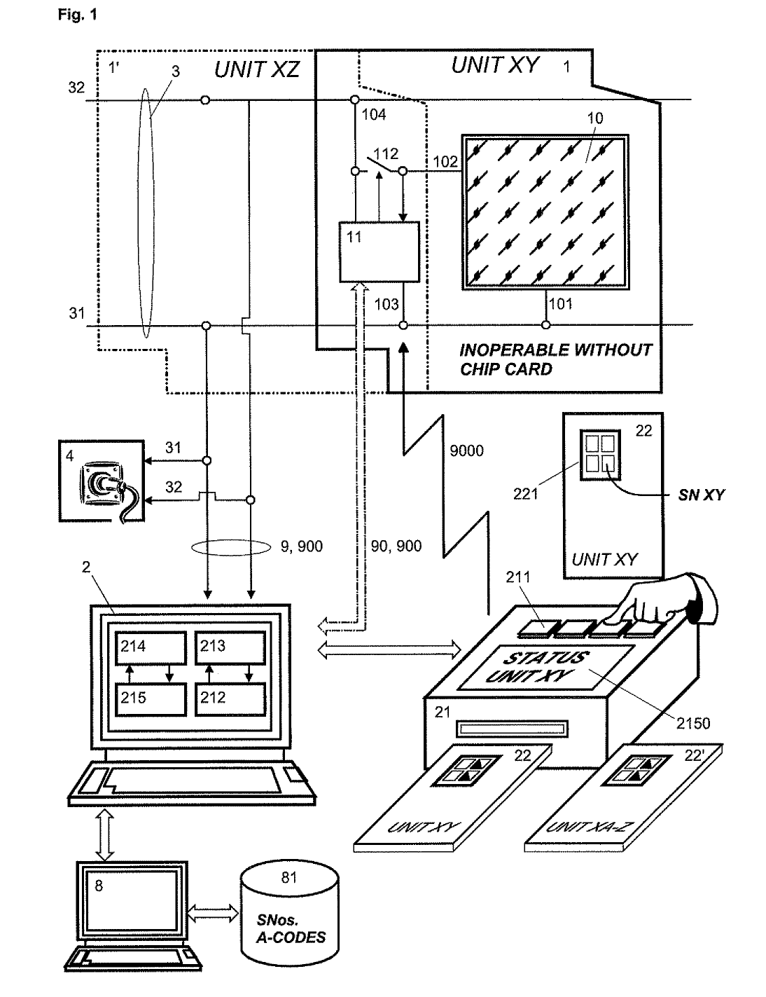

FIG. 1 shows an inventive energy supply system with a central control unit 2 and a protected solar module 1 that comprises a solar cell 10, which converts solar energy into electrical energy that can be transferred over a power line 3 to a load 4, such as an accumulator or a power converter, which e.g. is connected to a local or public network.

The solar module 1 is symbolically shown as a roof tile that is partially covered by another solar module 1′ or roof tile. However, the solar module 1 can have any other form or shape and can also be a wall member covering a wall of a building. Further each solar module may comprise one or a plurality of solar cells each disposed on an outer surface of said tile or wall member.

The solar module 1 may optionally comprise a passageway underlying at least the region of said tile or wall member where the solar cells 10 are located. The body of the solar module is preferably made of heat-conductive material such as metal. Hence, a liquid such as water that is guided through the passageway may collect thermal energy. Hence, the inventive energy supply system may not only deliver electrical energy but also of thermal energy that can be used for heating purposes or others. Further, removal of thermal energy from the solar modules protects the solar cells and the electronic circuitry, which then can operate more efficiently at lower temperatures. An energy supply system with solar modules comprising solar cells and a passageway is described for example in [2], EP 0 335 261 B1.

The solar cell 10 comprises two connection wires 101, 102. The first connection wire 101 is connected to a first wire 31 of the power line 3. The second connection wire 102 is connected to a switching module 112, which is connected to the second wire 32 of the power line 3. The solar module 1 further comprises a local control unit 11 that is connected to and is controlling the switching module 112 in such a way that the transfer of electrical energy from the photovoltaic cell 10 to the load 4 can be interrupted in the event that a verification process, involving an exchange of data between the central control unit 2 and the local control unit 11 has proven that the solar module 1 does not belong to the energy supply system.

In FIG. 1 the exchange of data is preferably performed over the power line wires 31, 32, to which the local control unit 11 is connected via wires 103 and 104 and the central control unit 2 over wires 9. Since, in the event of a failure of the verification procedures, the power line wires 31 and 32 are not cross-barred as in the system described in [1], the communication can still be executed via the power line 3. A communication channel 900 can alternatively be established over a separate communication line 90 that connects the local control unit 11 directly with the central control unit 2.

Further, the local control unit 11 is connected to the connection wires 101 and 102 of the solar cell 10, which provides electrical energy even in the event, that the verification process has failed. Hence, the local control unit 11 is always kept in operating condition and capable of exchanging data over the power line 3 or at the separate communication line 90 with the central control unit 2.

Particularly during installation procedures, when the source of an occurring problem is unknown, it is advantageous that the central control unit 2 can access all solar modules 1 individually and establish a complete status report for the energy supply system and all its modules. For example, the condition of the power line can be measured. Failures of the verification processes can be analysed, in order to determine whether the solar modules 1 do not belong to the energy supply system or an error has occurred. The central control unit 2 may download the serial numbers SN from the solar modules 1, which preferably are globally unique. The obtained serial numbers SN can then be sent to the manufacturer's data processing system 8 which compares the reported serial numbers SN with the entries in a register or database 81. This database 81 preferably contains the serial numbers and related data of solar modules 1 that were sold and reported stolen. Hence, within minutes not only the status of the inventive energy supply system but the complete status of all the solar modules can be identified. The database 81 may also contain data, such as an access code, relating to the solar modules 1 with which the verification process can be completed. However, the access code is preferably not made available in this way to maintenance personnel. In addition or as an alternative, the status of the solar modules 1 could also be reported to an alarm system.

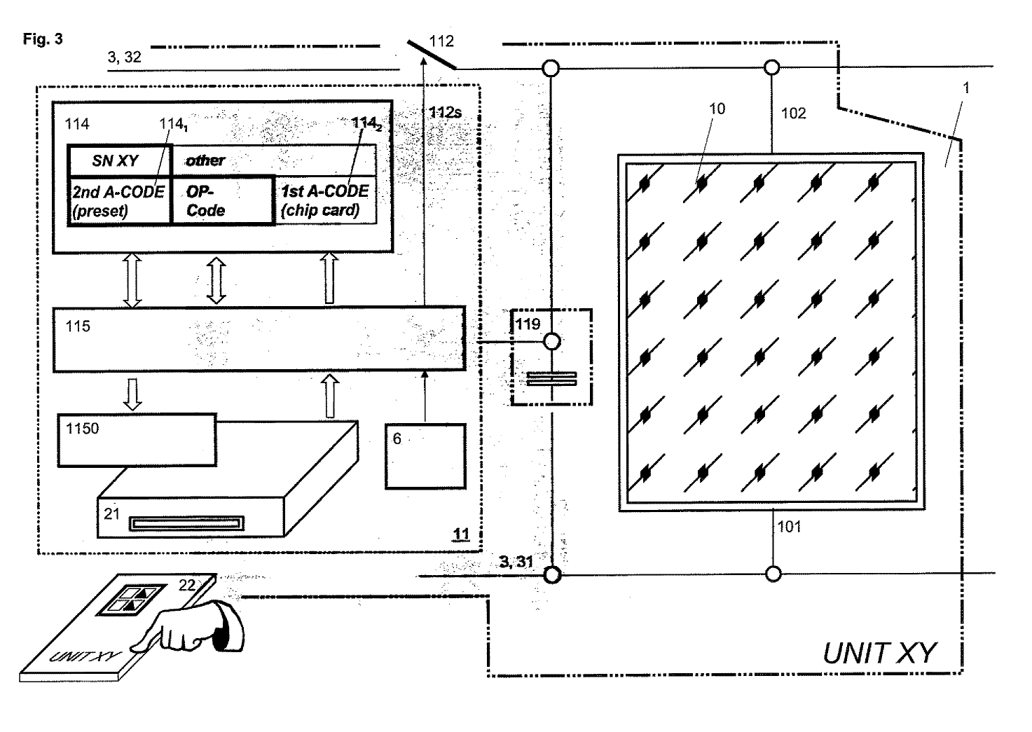

Instead, most preferably, a chip-card 22 with an electronic module 221 is provided for each or for a plurality of solar modules 1. The “chip”, i.e. an electronic module 221 comprises a first access code that corresponds to a second access code that is stored in the first location 114₁ of a memory unit 114 contained in the local control unit 11 (see FIG. 3). In order to activate the solar module 11 the chip-card 22 must be inserted into a card-reader 21 that is reading and transferring the first access code to the central control unit 2 as shown in FIG. 1 or directly to a second location 114₂ of the memory unit 114 contained in the local control unit 11 as shown in FIG. 3. The local control unit 11 then performs the verification procedure as explained above and is equipped with a program module that is designed for that purpose (see FIG. 3, OP-code).

Hence, with this embodiment, the solar module can only be operated, when the corresponding chip-card 22 is available. Unauthorised removal of a solar module is therefore not of benefit, if no access to the chip-card 22 is given. As shown in FIG. 1 a corresponding warning sign is preferably marked on the solar module 1, such as “NOTE: INOPERABLE WITHOUT CHIP-CARD”. This information will discourage third parties to get hold of protected solar modules 1.

Further, the solar modules 1 and the chip-cards 22 are preferably provided with identical marks or serial numbers (UNIT XY) that easily allow mutual allocation of the solar modules 1. Thus, an important aspect of the present invention is that the inventive solar modules 1 can easily be transferred from to and between installation sites without taking care of the access codes that will be required for the verification procedures. Since the solar modules 1 are transferred together with the related chip-cards 22 there is no need to identify and separately transfer the related access codes. Still further, also during the first installation the personnel requires the chip-card 22 only, without further administrative burden. In preferred embodiments the manufacturer can also store utilities and communication programs on the chip-card 22, so that even a remote access to the energy supply system by the manufacturer can easily be established. Further information such as product information can be stored on the chip-card 22 as well.

A chip-card 22, 22′ can cover only one solar module 1, e.g. with the serial number XY, or a plurality of solar modules 1, e.g. with the serial numbers XA, XB, . . . , XZ.

The chip card reader 21 can be attached to the central control system 2, to the local control system 11 in the solar module 1 or can be a portable unit that is hand carried by the personnel for installation and maintenance purposes. The mobile card reader 21 contains an accumulator or a battery and an input device 211, a display unit 2150 and at least one communication device such as an optical transceiver. In this configuration the card reader 21 is enhanced to an independent control panel, with which activation and maintenance procedures can be performed. Hence, maintenance personnel can approach the relevant solar modules 1 and perform activation and maintenance procedures, such as uploading the first access code to and downloading status and maintenance information, like the maximum and the average power supplied by the solar module, as well as identification information such as the serial number from the solar modules 1, whenever is required.

The embodiment with the card reader 21 being part of a portable control panel as shown in FIG. 1, provides further advantages. Maintenance personnel can introduce the chip card 22, 22′ into a card reader 21 and will find the information, particularly status information of the related solar modules 1 on the display 2150. Since the chip cards 22, 22′, . . . are unambiguously assigned to the related solar modules 1, service personnel can quickly and reliably interrogate the solar modules 1 and perform the required tests. On the display 2150, malfunctions, identification numbers and the operating status, particularly the current power output can be shown and registered as desired.

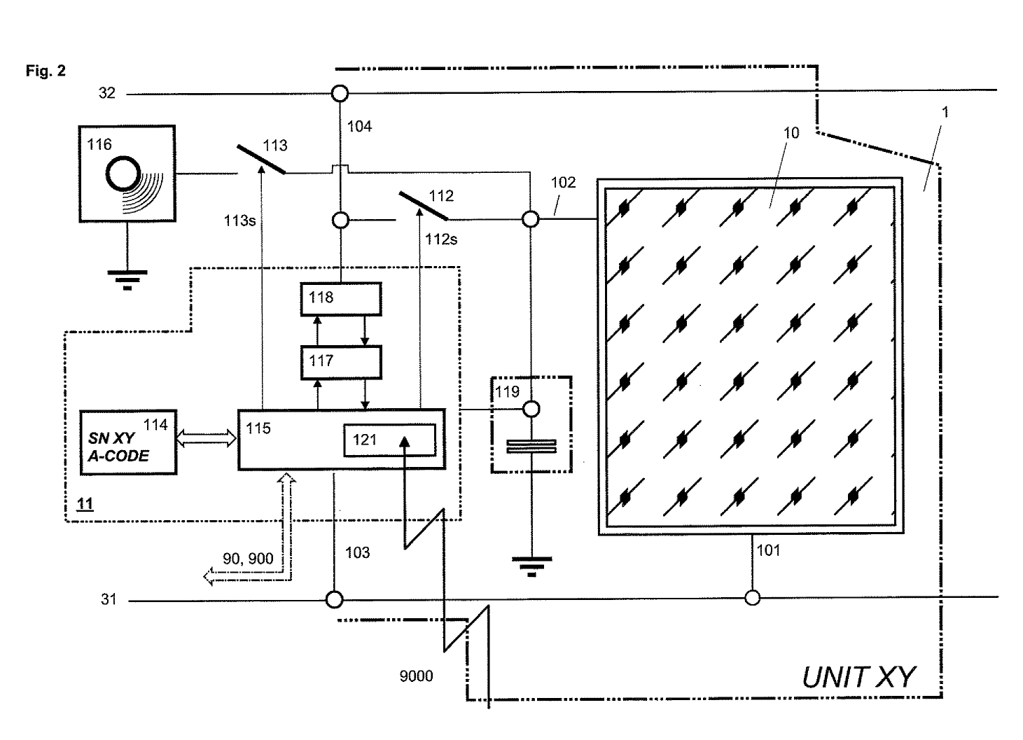

FIG. 2 shows the solar module 1, particularly the local control unit 11 of FIG. 1 in a preferred embodiment. It is shown that the local control unit 11 comprises a processing unit 115 connected to a memory unit 114, preferably comprising a read-only memory, in which the programming code, the preferably unique serial number SN XY, and the access code A-CODE are stored. Further shown is unit 117, which is used for converting digital and analogue signals depending on the direction of transfer and a unit 118, which is used for modulating and accordingly demodulating incoming signals depending on the direction of transfer. As an example, data provided by the processor 115 may be converted into analogue signals, with which a carrier frequency that is applied to the power line 3 is modulated. Any suitable modulation method such as frequency modulation may be applied. In the event that different carrier frequencies are used by the solar modules 1, then the communication between the central control unit 2 and several local control units 11 may take place in parallel. Alternatively, if the same carrier frequency is used, any suitable multiple access protocol may be applied. Further, the individual local control units 11 may communicate with the central control unit 2 within dedicated time slots.

Alternatively, the local control unit 11 may comprise a single chip computer that may even include analogue circuitry that performs the functions of the units 117 and 118.

In FIG. 2 it is further shown that the local control unit 11 is connected over two control lines 112s, 113s with the control inputs of the first and a second switching module 112, 113 respectively. As described above the first switching module 112 serves for connecting the second connection wire 102 of the solar cell 10 to the second power line wire 102 in the event that the solar module 1 has properly been identified. In the event that the verification process has failed, the first switching module 112 remains open, while the second switching module 113 is being closed in order to connect the second connection wire 102 of the solar cell 10 to a wireless signalling module 116, that for example indicates the failure of the verification procedure by emission of signals such as optical acoustical or radio signals.

Further shown in FIG. 2 is a power supply module 119 that is connected to the solar cell 10 and is providing a supply voltage to the local control unit 11, during times when the solar cell 10 is not providing electrical energy. The power supply module 119 may be a capacitor or an accumulator, or other.

As shown in FIG. 2 the activation code can be transferred wirelessly or cable bound to the local control module 115. For the wireless communication the local control module 115 comprises a transceiver 121, which is designed to exchange data with the mobile card reader 21. Wireless communication is preferably based on the exchange of optical signals, such as infrared signals, which can pass through a transparent protection layer that covers the circuitry provided in the solar module 1.

FIG. 3 shows a further important embodiment of an inventive solar module 1, which comprises a card-reader 21 and a motion sensor 6 that are connected to a processing unit 115 that is provided in the central control unit 11. The processing unit 115 stores the access code retrieved from the chip-card 22 in a memory unit 114, in which a preset access code, preferably a unique serial number and, preferably, the code of an operation program are already pre-stored, preferably in a non-volatile section of the memory unit 114. Alternatively the program for operating the solar module 1 could also be stored at least partially on the chip-card 22. Hence, for the initialisation of the solar module 1, the transfer of the access code and at least one program module would be required.

Further shown in FIG. 3 is a power supply module 119 that is connected to the solar cell 10 and is providing a supply voltage to the local control unit 11. Hence, as soon as the solar module 1 is installed, the local control unit 11 is powered with the required supply voltage. However, before the switching module 112 is closed and electrical energy is transferred over the power line wires 31, 32, the operating system implemented by the processing unit 115 awaits the entry of the access code contained on the chip-card 22. After the chip-card 22 is inserted into the card-reader 21 the access code is retrieved and stored in the memory unit 114. subsequently the retrieved access code is compared with the pre-stored access code and the switching unit 112 is activated in the event that the codes match. This comparison is repeatedly, e.g. periodically being executed in order to check whether the stored values still match. In the event that the solar module 1 is uninstalled and removed from the installation site, then the motion sensor 6 forwards a corresponding signal to the processing unit 115, which compares the level of the received signal with a pre-stored threshold and deactivates the solar module 1 in the event that the threshold is exceeded. Consequently, the values stored in the memory unit 114 will not match when the next comparison or test cycle is executed so that the switching unit 112 is reset and transfer of electrical energy through the power line wire 32 is interrupted. Hence, when reinstalling the solar module 1 the chip-card 22 must be reinserted into the card-reader 21 in order to perform the initialisation again. Therefore, if the solar module 1 has been removed without authorisation, reinstallation will not be possible, so that the solar module 1 will be of no value to the present holder. The solar module 1 can therefore be installed and autonomously be operated with a high level of protection even at remote places providing services to the entitled owner only.

Further, a deactivation of the solar module may also be performed, when a disconnection of the solar module 1 from the system has been detected by the local control module 11. Preferably the local control module 11 observes the impedance changes that will occur when the solar module 1 is disconnected. Further, it is possible to observe the receipt of control signals that are sent from the central control unit 2 and that will no longer be received as soon as the solar module 1 is disconnected.

Most preferred, the solar module 1 is deactivated only, if both conditions, the presence of a signal from the motion sensor and the detection of a disconnection of the solar module 1, are present.

In order to facilitate the procedures, a display unit 1150 may be provided that indicates the status of the solar module 1 or further data such as the serial number or product information.

Further, in order to reduce the average downtime of the solar modules 1, electrical failures of the activation circuitry are preferably detected and suppressed, so that they remain without influence on the system. E.g., in the event that a processor provided on the solar module 1 fails, then the solar module preferably remains activated.

In a further embodiment the solar modules 1 may comprise a transmitter that is activated, whenever a situation has occurred, which indicates theft of the solar module 1. The transmitter, which may be part of the control module 11 (e.g. the wireless signalling unit 116), may be triggered by the motion sensor 6. In this embodiment the stolen solar module 1 may even remain operative but can easily be found, by detecting the transmitter signal, while test driving in an area, where solar modules have recently been installed. However, the transmitter signal can trigger an external alarm system, which can alert security personnel. Further the signal emitted by the wireless signalling unit 116 may also be received and processed by the portable card reader, the centralised data processing system 8, 81 and/or an alarm system.

What has been described above is merely illustrative of the principles of the present invention. Other arrangements can be implemented by those skilled in the art without departing from the spirit and scope of protection of the present invention. In particular, features of the disclosed embodiments can be transferred between one another. E.g. the arrangement of the switching module 112 disclosed in FIG. 2 can be used in the embodiment of FIG. 3 and vice versa.

The chip-card can of course be used for other purposed as well. It is certainly advantageous integrate functions of a credit card into the chip-card so that the owner of the solar modules does not need an additional card and has concentrated important values and assets on a single card.

### REFERENCES

[1] U.S. Pat. No. 6,650,031 B1
[2] EP 0 335 261 B1

1. Energy supply system comprising at least one protected solar module with at least one photovoltaic cell and a local control unit connected to a switching module, which is controllable in such a way that the transfer of electrical energy from the photovoltaic cell via first and second wires of a power line to a load is interruptable in the event that a verification procedure that can be performed by the local control unit has provided a negative result, characterised in wherein a chip-card with an electronic module is provided for each or for a plurality of solar modules comprising a first access code that corresponds to a second access code stored in a memory unit, and that a card-reader is provided, with which the first access code is transferable from the electronic module to the memory unit contained in the local control unit, which comprises a program module that allows performing the verification procedure that involves comparing the first access code, which has been transferred to the memory unit, and the preset second access code, singularly or repeatedly.

2. Energy supply system according to claim 1, wherein
a) that the card-reader is connected to a central control unit; or
b) that the card-reader is detachably or firmly connected to or integrated into the local control unit and is preferably part of the solar module; or
c) that the portable card reader, that is equipped with input and output devices and a transmitter or a transceiver, allows wireless transfer of the access code by means of radio signals or optical signals such as infrared signals which can pass through a transparent protection layer that covers the circuitry provided in the solar module 1.

3. Energy supply system according to claim 1, wherein a motion sensor is connected to the local control unit, which is designed to deactivate the functionality of the solar module by erasing the first access code stored in the memory unit whenever a movement of the solar module is signalled by the motion sensor.

4. Energy supply system according to claim 1, wherein a first connection wire of the photovoltaic cell is connected to the first power line wire, that the second connection wire of the photovoltaic cell is connected via the switching module to the second power line wire and that the local control unit is connected on the one hand to the first and second connection wires of the photovoltaic cell and on the other hand via the first and second power line wires or via a separate communication line to the central control unit.

5. Energy supply system according to claim 1, wherein communication units are provided in the central control unit and in the local control unit trough which modulated signals are exchangeable over the power line wires.

6. Solar module for an energy supply system according to claim 1 that comprises at least one photovoltaic cell, a local control unit connected to a first switching module, which is controllable in such a way that the transfer of electrical energy from the photovoltaic cell via first and second power line wires to a load is interruptable in the event that a verification procedure that can be performed by the local control unit has provided a negative result, wherein a chip-card with an electronic module is provided comprising a first access code that corresponds to a second access code stored in a memory unit, and that a card-reader is provided for receiving the chip-card, with which the first access code is transferable from the electronic module to the memory unit contained in the local control unit, which comprises a program module that allows performing the verification procedure that involves comparing the first access code, which has been transferred to the memory unit, and the preset second access code, singularly or repeatedly.

7. Solar module according to claim 6, wherein that the card-reader is releasably or firmly connected to or integrated into the local control unit and is preferably part of the solar module.

8. Solar module according to claim 6, wherein a motion sensor is connected to the local control unit unit, which is designed to deactivate the functionality of the solar module by erasing the first access code stored in the memory unit whenever a movement of the solar module is signalled by the motion sensor.

9. Solar module according to claim 6, wherein at least the memory unit that stores the first access code is a non-volatile memory.

10. Solar module according to claim 7, wherein the local control unit is designed to deactivate the functionality of the solar module by erasing the first access code stored in the memory unit whenever a movement of the solar module is signalled by the motion sensor and/or a disconnection of the solar module from the system is detected.

11. Solar module according to claim 6, wherein a first connection wire of the photovoltaic cell is connected to the first power line wire, that the second connection wire of the photovoltaic cell is connected via the switching module to the second power line wire and that the local control unit is connected on the one hand to the first and second connection wires of the photovoltaic cell and on the other hand via the first and second power line wires or via a separate communication line to the central control unit.

12. Solar module according to claim 6, wherein the local control unit is connected directly or via an energy storage unit to the first and second connection wire of the photovoltaic cell and/or that a communication unit is provided in the central control unit, through which modulated signals are exchangeable over the power line with the central control unit.

13. Solar module according to claim 6, wherein the local control unit can activate a wireless signalling unit designed to emit signals such as acoustical, optical or radio signals, in the event that the verification procedure has provided a negative result; by connecting the second connection wire of the photovoltaic cell through a second switching module to wireless signalling unit.

14. Method for operating an energy supply system according to claim 6 that comprises at least one photovoltaic cell, a local control unit connected to a first switching module, which is controlled in such a way that the transfer of electrical energy from the photovoltaic cell via first and second power line wires to a load is interrupted in the event that a verification procedure that will be performed by the local control unit has provided a negative result, wherein a chip-card with an electronic module comprising a first access code that corresponds to a second access code stored in a memory unit is entered into a card-reader which reads the first access code from the electronic module and transfers the first access code to the memory unit contained in the local control unit, which uses a program module for performing the verification procedure that involves comparing the first access code, which has been transferred to the memory unit, and the preset second access code, singularly or repeatedly.

15. Method according to claim 14, wherein a motion sensor is connected to the local control unit, which deactivates the solar module by erasing the first access code stored in the memory unit whenever a movement of the solar module is signalled by the motion sensor

16. Method according to claim 14, wherein in the event of a verification failure the at least one photovoltaic cell is disconnected from the power line wires but not from the local control unit for which a communication channel over the power line wires remains maintained at least for periodically occurring time slots, so that maintenance personnel has access via the central control unit to all installed solar modules even in the event that verification of one or more solar modules failed.

17. Method according to claim 14, wherein at least one solar module comprises a serial number, which serves for addressing the solar module and for which the location of the solar module is stored in the central control unit and that for all installed solar modules status messages are collected during verification or after all verification processes have been completed.

18. Method according to claim 14, wherein the status and identification data of the installed solar modules is downloaded to the portable card reader and/or to a centralised data processing system such as the data processing system of the manufacturer or wherein the status of the solar modules is communicated, preferably by the wireless signalling unit unit, to the portable card reader and/or to the centralised data processing system and/or an alarm system.
